(19) United States
(12) Patent Application Publication
(10) Pub. No.: US 2022/0118334 A1
(43) Pub. Date: Apr. 21, 2022

(54) TEACHING AID FOR ROTARY PEDAL MOTION OF A PEDAL-DRIVEN WHEELED VEHICLE

(71) Applicant: PERRY CURTIS RZESNOSKI, ROSENORT (CA)

(72) Inventor: PERRY CURTIS RZESNOSKI, ROSENORT (CA)

(21) Appl. No.: 17/485,728

(22) Filed: Sep. 27, 2021

Related U.S. Application Data
(60) Provisional application No. 63/093,861, filed on Oct. 20, 2020.

(51) Int. Cl. A63B 69/16; B62H 7/00

(52) U.S. Cl. CPC A63B 69/16; B62H 7/00

(57) ABSTRACT

A teaching aid for rotary motion of a pedal-driven wheeled vehicle features an arm configured to span from a lower end thereof positioned at a rotary pedal assembly of the pedal-driven wheeled vehicle in an upwardly and longitudinally inclined orientation to an upper end of the arm positioned at a longitudinally spaced location from the seat of the pedal-driven wheeled vehicle, which upper end is configured for gripping by a user. The aid further features a connector supported on the arm at or adjacent the lower end thereof, which is configured for attaching to the rotary pedal assembly on one side of the vehicle and at a spaced location from an axis of rotation of the rotary pedal assembly such that the arm acts as an extension for the user to drive rotary motion of the rotary pedal assembly by the user's hand.

This applications claims the benefit under 35 U.S.C. 119(e) of U.S. Provisional application Ser. No. 63/093,861 filed Oct. 20, 2020.

### FIELD OF THE INVENTION

The present invention relates generally to a teaching aid for a pedal-driven wheeled vehicle, such as a bicycle, and more particularly to such a teaching aid for driving, by hand, a rotary pedal assembly of the wheeled vehicle located below a seat thereof for receiving a rider, while standing on a support surface either in front of or behind the seat.

### BACKGROUND

Most teaching aids for pedal-driven wheeled vehicles, such as bicycles, focus on teaching a rider to maintain or balance the wheeled vehicle in an upstanding condition suited for locomotion thereof. However another aspect of learning to operate a pedal-driven wheeled vehicle is learning rotary motion of the feet for driving a rotary pedal assembly of the wheeled vehicle.

### SUMMARY OF THE INVENTION

It is an object of the invention to provide a teaching aid for rotary pedal motion of a pedal-driven wheeled vehicle.

Typically the pedal-driven wheeled vehicle has:

a frame having a front end, a rear end on a longitudinally opposite end of the frame, and opposite sides,

a front wheel rotatably mounted at the front end of the frame for rolling engagement with a support surface,

a rear wheel rotatably mounted at the rear end of the frame for rolling engagement with the support surface,

wherein one of the front and rear wheels is steerable so as to direct movement of the pedal-driven wheeled vehicle in a forward direction,

a seat supported by the frame and arranged for receiving a seated rider,

a rotary pedal assembly operatively coupled to one of the front and rear wheels and configured to drive said one of the front and rear wheels for rotation to travel in the forward direction of movement of the pedal-driven wheeled vehicle,

wherein the rotary pedal assembly is supported below the seat,

wherein the rotary pedal assembly has a hub defining an axis of rotation of the rotary pedal assembly, a pair of cranks each of which is on one of the opposite sides of the frame and is connected to the hub, wherein each crank extends radially outwardly from the axis of rotation at an angularly spaced location about said axis from another one of the cranks, and pedals supported on the cranks at spaced locations from the axis of rotation and configured for receiving the feet of the seated rider to effect rotary motion of the rotary pedal assembly.

According to an aspect of the invention there is provided a teaching aid comprising:

an arm extending from an upper end to a lower end, wherein the arm is configured to span from the lower end positioned at the rotary pedal assembly of the pedal-driven wheeled vehicle in an upwardly and longitudinally inclined orientation to the upper end positioned at a longitudinally spaced location of the seat of the pedal-driven wheeled vehicle, wherein the spaced location of the upper end of the arm relative to the seat is in a common longitudinal direction as a longitudinal component of the inclined orientation of the arm;

wherein the upper end of the arm is configured for gripping by a user; and

a connector supported on the arm at or adjacent the lower end thereof, wherein the connector is configured for attaching to the rotary pedal assembly on one side of the frame and at a spaced location from the axis of rotation of the rotary pedal assembly such that the arm acts as an extension for the user to drive rotary motion of the rotary pedal assembly by the user's hand while (i) in an upright body position located in longitudinally spaced relation to the seat of the pedal-driven wheeled vehicle and (ii) on the support surface.

According to another aspect of the invention there is provided a teaching aid for a pedal-driven wheeled vehicle,

wherein the pedal-driven wheeled vehicle has:
a frame having a front end, a rear end on a longitudinally opposite end of the frame, and opposite sides,
a front wheel rotatably mounted at the front end of the frame for rolling engagement with a support surface,
a rear wheel rotatably mounted at the rear end of the frame for rolling engagement with the support surface,
wherein one of the front and rear wheels is steerable so as to direct movement of the pedal-driven wheeled vehicle in a forward direction,
a seat supported by the frame and arranged for receiving a seated rider,
a rotary pedal assembly operatively coupled to one of the front and rear wheels and configured to drive said one of the front and rear wheels for rotation to travel in the forward direction of movement of the pedal-driven wheeled vehicle,
wherein the rotary pedal assembly is supported below the seat,
wherein the rotary pedal assembly has a hub defining an axis of rotation of the rotary pedal assembly, a pair of cranks each of which is connected to the hub on one of the opposite sides of the frame and extends radially outwardly from the axis of rotation at an angularly spaced location about said axis from another one of the cranks, and pedals supported on the cranks at spaced locations from the axis of rotation and configured for receiving the feet of the seated rider to effect rotary motion of the rotary pedal assembly,

the teaching aid, in combination with the pedal-driven wheeled vehicle, comprising:

an arm extending from an upper end to a lower end;

wherein the upper end of the arm is configured for gripping by a user; and

a connector supported on the arm at or adjacent the lower end thereof, wherein the connector is removably attached to the rotary pedal assembly on one side of the frame and at a spaced location from the axis of rotation of the rotary pedal assembly;

wherein when the connector is removably attached to the rotary pedal assembly on one side of the frame and at a spaced location from the axis of rotation of the rotary pedal assembly, the arms spans from the lower end thereof in an upwardly and longitudinally inclined orientation to the upper end positioned at a longitudinally spaced location of the seat of the pedal-driven wheeled vehicle for gripping by the user to drive rotary motion of the rotary pedal assembly by the user's hand while (i) in an upright body position located in longitudinally spaced relation to the seat of the pedal-driven wheeled vehicle in a common longitudinal direction as a longitudinal component of the inclined orientation of the arm and (ii) on the support surface.

Preferably, in the upwardly and longitudinally inclined orientation of the arm, the upper end of the arm is arranged rearwardly of the seat of the pedal-driven wheeled vehicle.

Preferably, the arm extends linearly from the upper end to the lower end.

Preferably, the arm is rigid.

Typically, the arm comprises an upper side arranged for facing upwardly, an opposite underside arranged for facing downwardly, an outer side arranged for facing away from the pedal-driven wheeled vehicle, and an inner side arranged for facing the pedal-driven wheeled vehicle.

Preferably, the connector is supported on the inner side of the arm.

In at least one arrangement, the connector is configured for attaching to one of the pedals.

In one arrangement, the connector comprises a rounded shaft projecting from a side of the arm and configured for insertion into an opening in a corresponding one of the pedals.

In another arrangement, the connector comprises a pedal receptacle supported on a side of the arm and configured to receive an outer end of the pedal therein.

In such an arrangement, the pedal receptacle may be pivotally supported on the arm for rotation about an axis transverse to the arm.

In at least one arrangement, there is provided another one of the arm with the connector for attaching to the rotary pedal assembly for use on an opposite side of the frame to cooperatively drive the rotary pedal assembly. That is, the teaching aid comprises a pair of the arms each with the connector for attaching to one of the pedals, for cooperative use. In such an arrangement, each of the arms is located on an opposite side of the pedal-driven wheeled vehicle.

According to yet another aspect of the invention there is provided a method for turning a rotary pedal assembly of a pedal-driven wheeled vehicle comprising:

attaching a hand-held device to the rotary pedal assembly at a spaced location from an axis of rotation thereof, wherein the hand-held device is configured to extend in inclined orientation from an attachment location on the rotary pedal assembly to a longitudinally spaced location from a seat of the pedal-driven wheeled vehicle;

while maintaining the hand-held device in said inclined orientation, displacing an upper end of the hand-held device in a rotary motion to drive the rotary pedal assembly of the pedal-driven wheeled vehicle.

Typically, the step of displacing an upper end of the hand-held device in a rotary motion is performed while standing on a support surface with which the pedal-driven wheeled vehicle is in rolling engagement.

Preferably, each of the steps of (i) attaching a hand-held device to the rotary pedal assembly and (ii) displacing an upper end of the hand-held device in a rotary motion is performed with a pair of the hand-held devices on opposite sides of the pedal-driven wheeled vehicle.

Preferably, in the inclined orientation an upper end of the hand-held device is positioned behind the seat of the pedal-driven wheeled vehicle.

### BRIEF DESCRIPTION OF THE DRAWINGS

The invention will now be described in conjunction with the accompanying drawings in which:

FIG. 1 is an elevational view of a teaching aid according to the present invention in use, showing a user (schematically shown) relative to the teaching aid and a bicycle;

FIG. 2 is a top plan view of the teaching aid of FIG. 1 in use, where the user's body is not shown;

FIG. 3 is a perspective view of one arrangement of teaching aid according to the present invention;

FIG. 4 is an elevation view thereof;

FIG. 5 is a plan view thereof;

FIG. 6 is a plan view of a second arrangement of teaching aid according to the present invention; and

FIG. 7 is an elevation view thereof.

In the drawings like characters of reference indicate corresponding parts in the different figures.

### DETAILED DESCRIPTION

The accompanying figures show a hand-held teaching aid 10 for rotary motion of a rotary pedal assembly 1 of a pedal-driven wheeled vehicle 2, such as a bicycle.

Generally speaking, the pedal-driven wheeled vehicle 2 comprises a frame 3 having a front end 3A, a rear end 3B on a longitudinally opposite end of the frame, and opposite sides 3C. In the illustrated arrangement, the frame 3 comprises a network of interconnected elongate members.

The vehicle 2 further includes a front wheel 4A rotatably mounted at the front end 3A of the frame for rolling engagement with a support surface S, such as a roadway or ground, and a rear wheel 4B rotatably mounted at the rear end 3B of the frame, so as to be spaced from the front wheel, for rolling engagement with the support surface S.

At least one of the front and rear wheels is steerable so as to direct movement of the pedal-driven wheeled vehicle in a forward direction F. In the illustrated arrangement, it is the front wheel 4A which is steerable via a steering device 5, such as handlebars, which are operatively connected to the steerable wheel and which are operatively supported on the frame 3.

The vehicle 2 further includes a seat 6 supported by the frame 3 and arranged for receiving a seated rider who will manually propel the pedal-driven wheeled vehicle. The seat 6 is supported intermediate the front and rear ends 3A, 3B of the frame and at a longitudinally spaced location from the steering device 5, in this case in a rearward direction therefrom. The seat 6 is supported on a height-adjustable pole connected to the frame extending above the frame 3.

When the front wheel 4A is steerable, the seat 6 is located closer to the rear end 3B of the frame instead of the front end 3A thereof. This allows the user to be more comfortably seated for operating the pedal-driven wheeled vehicle, including to steer and to propel the rotary pedal assembly in a forward rotational direction corresponding to forward movement of the vehicle in the direction of arrow F.

In regard to propulsion, the rotary pedal assembly 1 is operatively coupled to one of the front and rear wheels 4A, 4B and is configured to drive the corresponding one of the front and rear wheels for rotation to travel in the forward direction of movement of the pedal-driven wheeled vehicle indicated at F. In other words, the rotary pedal assembly 1 is drivably coupled to a corresponding one of the wheels that is driven for locomotion or for propelling the vehicle 2. In the illustrated arrangement, the rotary pedal assembly 1 is drivably coupled to the rear wheel 4B via a conventional arrangement comprising an endless loop member in the form of a chain entrained on a toothed ring carried at a center of the rear wheel 4B. The endless chain is also entrained on the rotary pedal assembly 1 which is of a conventional type, as will be described shortly.

Turning now to the rotary pedal assembly 1, this is operatively rotatably supported on the frame 3 below the seat 6 such that the seated rider's feet are used to rotate the pedal assembly 1. When the front wheel 4A is steerable, the rotary pedal assembly 1 typically lies along an upright axis with the seat 6, which axis is more vertical than horizontal, such that a seated rider is located generally over the rotary pedal assembly 1.

In order to utilize the rider's feet to drive rotation of the driven wheel, the rotary pedal assembly 1 has a central hub 7 rotatably supported on the frame 3 and defining an axis of rotation A of the rotary pedal assembly. The central hub 7 is the component of the pedal assembly which is operatively connected to the drive wheel, in this case rear wheel 4B, which in the illustrated arrangement is achieved by an endless chain entrained over a toothed ring supported on the hub 7.

The rotary pedal assembly 1 also includes a pair of cranks 8 each of which is on one of the opposite sides 3C of the frame and is connected to the hub 7, with each crank 8 extending radially outwardly from the rotational axis A at an angularly spaced location about the axis A from another one of the cranks. Typically, the cranks 8 are spaced apart by 180 degrees around the rotational axis A of the pedal assembly, so as to extend in radially opposite directions.

Pedals 9 of the pedal assembly are supported on the cranks 8 at outwardly spaced locations from the axis of rotation A and are configured for receiving the feet of the seated rider to effect rotary motion of the rotary pedal assembly. The pedals 9 are supported at free ends of the cranks 8 which are distal to the rotational axis A.

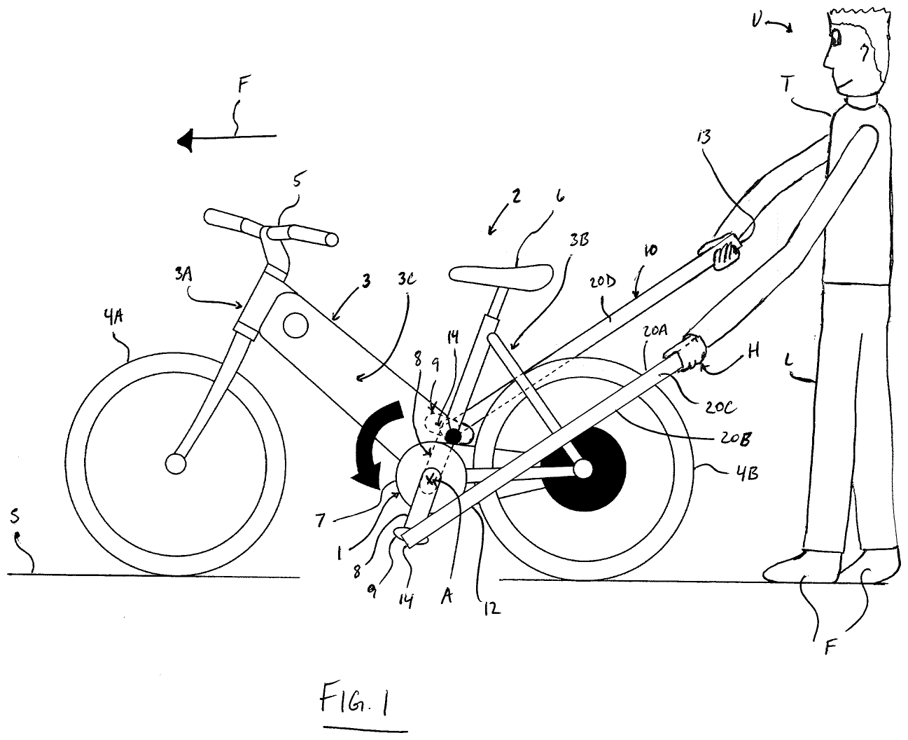

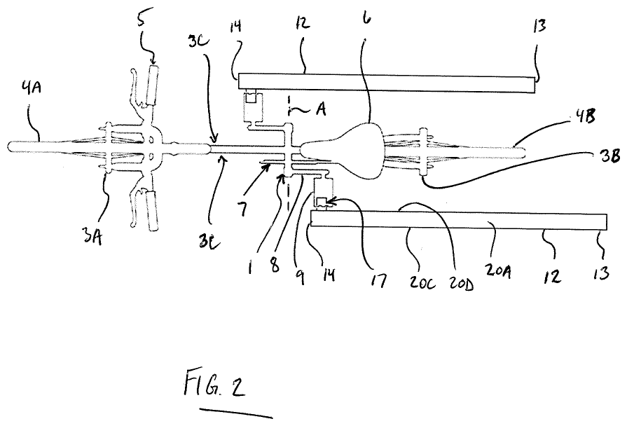

Based on the foregoing description of the pedal-driven wheeled vehicle, one example thereof is a conventional bicycle as illustrated in FIGS. 1 and 2.

Turning now to the teaching aid 10, this comprises a rigid arm 12 extending linearly from an upper end 13 to a lower end 14. The arm 12 is configured to span from the lower end 14 positioned at the rotary pedal assembly 1 of the pedal-driven wheeled vehicle in an upwardly and longitudinally (relative to the vehicle frame 3) inclined orientation to the upper arm end 13 positioned at a longitudinally spaced location of the vehicle seat 6. The spaced location of the upper end 13 of the arm 12 relative to the seat 6 is in a common longitudinal direction as a longitudinal component of the inclined orientation of the arm. For instance, when the arm 12 is inclined upwardly and rearwardly, then the upper end 13 is positioned rearwardly of the seat 6, as shown in FIGS. 1 and 2. Similarly, when the arm 12 is inclined upwardly and forwardly from the rotary pedal assembly 1, then the upper arm end 13 is positioned forwardly of the seat 6, and furthermore forwardly of the steering device 5 when the same is located forwardly of the seat as in most arrangements.

Thus in general the arm 12 is configured, primarily by sizing, to extend from the rotary pedal assembly 1 located at a bottom of the frame 3 intermediate the front and rear ends thereof 3A, 3B and to a location either in front of or behind the frame 3, that is either in front of the front end 3A or behind the rear end 3B, as this is generally where a user operating the teaching aid 10 can be positioned relative to the vehicle.

The teaching aid 10 further includes a connector 17 supported on the arm 12 at or adjacent the lower end 14 thereof. The connector 17 is configured for removably attaching to the rotary pedal assembly 1 on one side 3C of the frame and at a spaced location from the axis of rotation A of the rotary pedal assembly. Usually the connector 17 is configured for attaching either to a crank 8 or to a pedal 9 in order to position the lower end 14 of the arm at an outwardly spaced location from the rotational axis A, so that the arm 12 can be used to apply a torque to rotate the hub 7.

Furthermore, it will be appreciated that the upper end 14 of the arm is configured for gripping by a user, for example by being sized and shaped to fit in a user's hand H.

As such, the arm 12 acts as an extension for the user to drive rotary motion of the rotary pedal assembly by the user's hand H while (i) in an upright body position located in longitudinally spaced relation to the seat 6 of the pedal-driven wheeled vehicle and (ii) on the support surface S, as in FIG. 1 which shows the user's feet F on the support surface S. That is, using the teaching aid 10, the user's torso T may be disposed substantially vertically in-line with the user's legs L, which are substantially straightened, so that the user is self-supported on the support surface S.

The teaching aid 10 is used by, initially, attaching the hand-held teaching device 10 to the rotary pedal assembly 1 at a spaced location from the axis of rotation A thereof, and doing so in a manner that the hand-held device 10 extends in inclined orientation, on one side 3C of the vehicle 2, from its attachment location on the rotary pedal assembly 1 to a longitudinally spaced location from the seat 6 of the pedal-driven wheeled vehicle. Then, the upper end 14 is displaced in a rotary motion to drive the rotary pedal assembly 1 of the pedal-driven wheeled vehicle 2 while the hand-held device 10 is maintained in its inclined orientation.

Basically, the teaching aid 10 allows the user U standing either in front or behind the pedal-driven wheeled vehicle 2 to effect the rotary motion of the pedals 9, to rotate the pedal assembly 1, which is normally achieved by a seated rider's feet positioned on the pedals, using the user's hands H while maintaining an upright standing position on the support surface S across which the vehicle is to be displaced. By connecting the teaching aid 10 to the rotary pedal assembly 1 on one of the sides 3C of the frame, the user U can use circular elliptical motion of his/her hand H at a location which is above and longitudinally spaced from the rotary pedal assembly 1.

Turning back now to a structure of the teaching aid 10, the arm 12 thereof comprises an upper side 20A arranged for facing upwardly, for example towards the sky; an opposite underside 20B arranged for facing downwardly, that is towards the support surface S; an outer side 20C arranged for facing away from the pedal-driven wheeled vehicle 2; and an inner side 20D arranged for facing the pedal-driven wheeled vehicle.

The connector 17 is supported on the inner side 20D of the arm. Thus, when the arm 12 is attached to the rotary pedal assembly, the arm 12 is located outwardly of the rotary pedal assembly 1 in distal relation to the frame 3. In general, when the arm 12 is attached to the rotary pedal assembly 1 it is disposed on one side 3C of the vehicle frame 3.

In the illustrated arrangements, of which there are two, the connector 17 is configured for attaching to one of the pedals 9 of the pedal assembly 1. The pedals 9 provide a convenient mounting location and also, by connecting to same, the lower end 14 of the arm 12 is disposed in a position which is visible to the seated rider. Furthermore, by locating the teaching aid 10 outwardly of the rotary pedal assembly, and for example not between the crank 8 and the frame 3, there is a lower likelihood that the arm 12 is impeded in its circular elliptical motion by components of the pedal-driven wheeled vehicle 2.

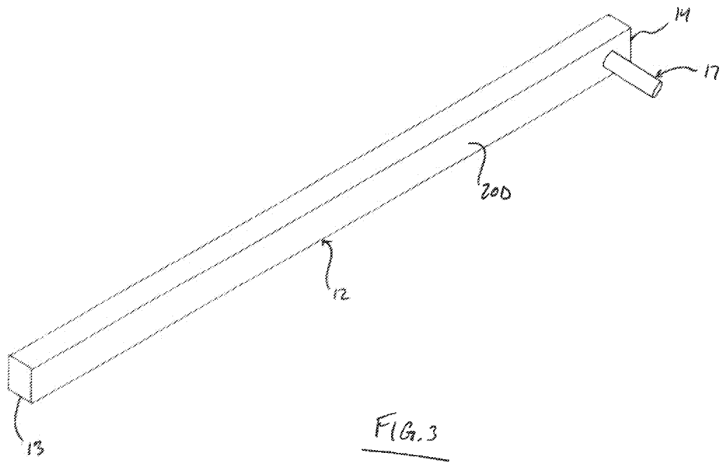

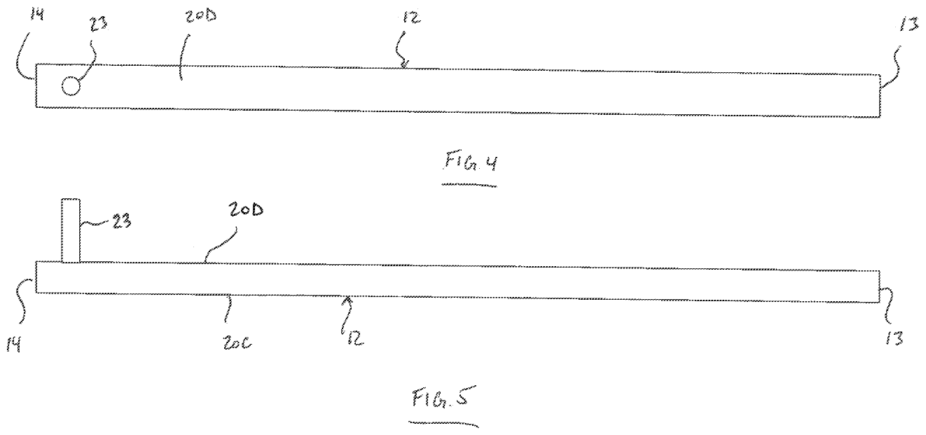

In FIGS. 3-5 there is shown a first arrangement of connector which comprises a rounded shaft 23 projecting from a side of the arm, in this case the inner side 20D, and configured for insertion into an opening in an outer side of a corresponding one of the pedals 9. That is, a conventional bicycle pedal has a shaft-receiving passageway, whereby it is connected to the crank, but the pedal-crank interconnecting shaft extends only partially through this passageway leaving an outer end portion thereof empty so as to be suited for receiving the connector shaft 23 of the aid 10.

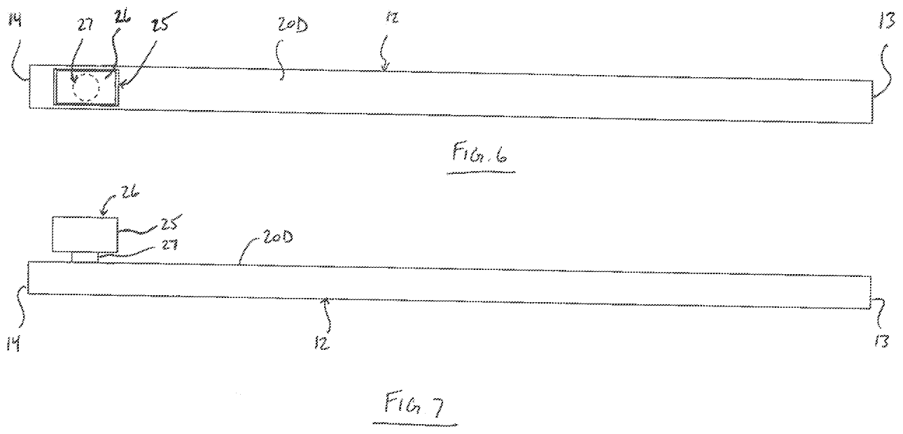

FIGS. 6 and 7 show another arrangement of connector which comprises a pedal receptacle 25 supported on a side of the arm, in this case the inner side 20D, and configured to receive an outer end of the pedal therein. Thus the pedal receptacle defines a cavity 26 which opens away from the inner side 20D of the arm and which is configured to matably receive an outer end portion of one of the pedals, for example by being sized and shaped so that the outer end pedal portion is snugly received in the receptacle 25. In the illustrated arrangement, the pedal receptacle 25 is pivotally supported on the arm by an interconnecting shaft 27 for rotation of the receptacle 25, with the pedal, about an axis transverse to the arm.

Thus, in use of the illustrated arrangements of teaching aid, the hand-held arm 12 is attached to the pedal 9 via the connector 17 so that the teaching aid 10 is connected to the rotary pedal assembly 1 at a spaced location from the rotational axis A thereof. In the attached position the arm 12 is arranged to span in inclined orientation from the attachment location at the pedal 9 to the upper end 13 at a longitudinally spaced location from the seat 6 of the pedal-driven wheeled vehicle. Then, while maintaining the hand-held arm 12 in the inclined orientation, the upper end 13 of the arm is displaced in a rotary motion to drive or rotate the rotary pedal assembly, so as to propel the vehicle 2 across the support surface.

More specifically, the rotary motion of the teaching aid 10 is a generally elliptical motion of the upper end 13 of the arm 12 while the arm 12 is maintained in its inclined orientation. If the arm 12 is maintained in substantially fixed orientation, that is to have a relatively fixed angle relative to the horizontal, then the elliptical motion of the upper end 13 of the arm becomes circular elliptical just like the motion of the cranks and pedals.

As previously mentioned the step of displacing the upper end 13 in a rotary motion is performed while standing on the support surface S with which the pedal-driven wheeled vehicle is in rolling engagement.

It will be appreciated that there may be provided, as shown in FIGS. 1 and 2, another one of the arm 12 with the connector 17 for attaching to the rotary pedal assembly 1 for use on an opposite side 3C of the frame to cooperatively drive the rotary pedal assembly. That is, the teaching aid 10 may comprise a pair of the arms 12 with the connectors 17 for attaching to one of the pedals, for cooperative use. In such an arrangement, each of the arms is located on an opposite side 3C of the pedal-driven wheeled vehicle 2.

Thus, in such an arrangement, each of the steps of (i) attaching a hand-held device to the rotary pedal assembly and (ii) displacing an upper end of the hand-held device in a rotary motion is performed with a pair of the hand-held devices on opposite sides of the pedal-driven wheeled vehicle.

The scope of the claims should not be limited by the preferred embodiments set forth in the examples but should be given the broadest interpretation consistent with the specification as a whole.

1. A teaching aid for a pedal-driven wheeled vehicle,
wherein the pedal-driven wheeled vehicle has:
a frame having a front end, a rear end on a longitudinally opposite end of the frame, and opposite sides,
a front wheel rotatably mounted at the front end of the frame for rolling engagement with a support surface,
a rear wheel rotatably mounted at the rear end of the frame for rolling engagement with the support surface,
wherein one of the front and rear wheels is steerable so as to direct movement of the pedal-driven wheeled vehicle in a forward direction,
a seat supported by the frame and arranged for receiving a seated rider,
a rotary pedal assembly operatively coupled to one of the front and rear wheels and configured to drive said one of the front and rear wheels for rotation to travel in the forward direction of movement of the pedal-driven wheeled vehicle,
wherein the rotary pedal assembly is supported below the seat,
wherein the rotary pedal assembly has a hub defining an axis of rotation of the rotary pedal assembly, a pair of cranks each of which is connected to the hub on one of the opposite sides of the frame and extends radially outwardly from the axis of rotation at an angularly spaced location about said axis from another one of the cranks, and pedals supported on the cranks at spaced locations from the axis of rotation and configured for receiving the feet of the seated rider to effect rotary motion of the rotary pedal assembly,
the teaching aid, in combination with the pedal-driven wheeled vehicle, comprising:
an arm extending from an upper end to a lower end;
wherein the upper end of the arm is configured for gripping by a user; and
a connector supported on the arm at or adjacent the lower end thereof, wherein the connector is removably attached to the rotary pedal assembly on one side of the frame and at a spaced location from the axis of rotation of the rotary pedal assembly;
wherein when the connector is removably attached to the rotary pedal assembly on one side of the frame and at a spaced location from the axis of rotation of the rotary pedal assembly, the arms spans from the lower end thereof in an upwardly and longitudinally inclined orientation to the upper end positioned at a longitudinally spaced location from the seat of the pedal-driven wheeled vehicle for gripping by the user to drive rotary motion of the rotary pedal assembly by the user's hand while (i) in an upright body position located in longitudinally spaced relation to the seat of the pedal-driven wheeled vehicle in a common longitudinal direction as a longitudinal component of the inclined orientation of the arm and (ii) on the support surface.

2. The teaching aid of claim 1 wherein the arm extends linearly from the upper end to the lower end.

3. The teaching aid of claim 1 wherein the arm is rigid.

4. The teaching aid of claim 1 wherein the arm comprises an upper side arranged for facing upwardly, an opposite underside arranged for facing downwardly, an outer side arranged for facing away from the pedal-driven wheeled vehicle, and an inner side arranged for facing the pedal-driven wheeled vehicle and wherein the connector is supported on the inner side of the arm.

5. The teaching aid of claim 1 wherein the connector is configured for attaching to one of the pedals.

6. The teaching aid of claim 5 wherein the connector comprises a rounded shaft projecting from a side of the arm and configured for insertion into an opening in a corresponding one of the pedals.

7. The teaching aid of claim 5 wherein the connector comprises a pedal receptacle supported on a side of the arm and configured to receive an outer end of the pedal therein.

8. The teaching aid of claim 7 wherein the pedal receptacle is pivotally supported on the arm for rotation about an axis transverse to the arm.

9. The teaching aid of claim 1 further including another one of said arm with said connector for attaching to the rotary pedal assembly for use on an opposite side of the frame to cooperatively drive the rotary pedal assembly.

10. The teaching aid of claim 1 wherein, in the upwardly and longitudinally inclined orientation of the arm, the upper end of the arm is arranged rearwardly of the seat of the pedal-driven wheeled vehicle.

11. A method for turning a rotary pedal assembly of a pedal-driven wheeled vehicle having longitudinally opposite front and reads end, the method comprising:
attaching a hand-held device to the rotary pedal assembly at a spaced location from an axis of rotation thereof, wherein the hand-held device is configured to extend in inclined orientation from an attachment location on the rotary pedal assembly to a longitudinally spaced location from a seat of the pedal-driven wheeled vehicle;
while maintaining the hand-held device in said inclined orientation, displacing an upper end of the hand-held device in a rotary motion to drive the rotary pedal assembly of the pedal-driven wheeled vehicle.

12. The method of claim 11 wherein each of the steps of (i) attaching a hand-held device to the rotary pedal assembly and (ii) displacing an upper end of the hand-held device in a rotary motion is performed with a pair of the hand-held devices on opposite sides of the pedal-driven wheeled vehicle.

13. The method of claim 11 wherein displacing an upper end of the hand-held device in a rotary motion is performed while standing on a support surface with which the pedal-driven wheeled vehicle is in rolling engagement.

14. The method of claim 11 wherein in the inclined orientation an upper end of the hand-held device is positioned behind the seat of the pedal-driven wheeled vehicle.
